(19) United States
(12) Patent Application Publication
(10) Pub. No.: US 2020/0392736 A1
(43) Pub. Date: Dec. 17, 2020

(54) ROOFTOP GARDEN

(71) Applicant: MATERGENICS, INC., Pittsburgh, PA (US)

(72) Inventors: Mehrooz Zamanzadeh, Pittsburgh, PA (US); Carolyn Tome, Pittsburgh, PA (US); Peyman Taheri Bonab, Vancouver (CA)

(73) Assignee: MATERGENICS, INC., Pittsburgh, PA (US)

(21) Appl. No.: 16/898,974

(22) Filed: Jun. 11, 2020

Related U.S. Application Data
(60) Provisional application No. 62/860,416, filed on Jun. 12, 2019.

(51) Int. Cl. E04D 13/00; C23F 13/22; C23F 13/14; A01G 9/033; H02S 20/23; H02S 40/38

(52) U.S. Cl. CPC E04D 13/00; C23F 13/22; H02S 40/38; A01G 9/033; H02S 20/23; C23F 13/14

(57) ABSTRACT

A metal (carbon steel) tank receives growth media containing an electrolyte. An anode is positioned within the growth media in electrical contact with the metal tank to polarize the anode and the metal tank with a potential difference therebetween. The metal tank becomes a cathode when a potential difference is established between the metal tank and the anode. The anode, the cathode, and the electrolyte form an electrochemical cell. The carbon steel tank will be protected for twenty to thirty years.

### CROSS REFERENCE TO RELATED APPLICATION

This application claims the benefit under 35 U.S.C. § 119(e) of co-pending U.S. Provisional Application No. 62/860,416 entitled “ROOFTOP GARDEN” filed Jun. 12, 2019, which is incorporated herein by reference.

### BACKGROUND

Rooftop gardens, also called living roofs or green roofs, have many advantages, including reduction of urban heat island effect, providing more space for agriculture, adding beauty to the cityscape, increasing air quality, and enhancement in building insulation. Such gardens can include plants that remove carbon dioxide from the air and release oxygen back into the air.

Rooftop gardens must include a stable waterproof layer. Rooftop gardens must also be protected against mechanical damage from wind and other weather phenomena, including extreme temperatures, UV radiation, etc. Moreover, the environment within the rooftop garden can be extremely corrosive due to the presence of water and electrolytes, so that material choices are limited.

Conventional rooftop gardens can be constructed from concrete. However, concrete structures tend to be heavy and inefficient, specifically such structures are inefficient to assemble and/or to maintain on the top of a building. Moreover, such structures are prone to leak. Accordingly, an improved rooftop garden and method for constructing such a garden is needed.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, a rooftop garden includes a metal tank for receiving growth media containing an electrolyte. An anode is positioned within the growth media in electrical contact with the metal tank to polarize the anode and the metal tank with a potential difference therebetween. The metal tank becomes a cathode when a potential difference is established between the metal tank and the anode. The anode, the cathode, and the electrolyte form an electrochemical cell.

In other implementations, a method for assembling a rooftop garden includes providing a metal tank for receiving growth media containing an electrolyte. A cathode is formed through the insertion of an anode into the metal tank in electrical contact therewith resulting in the polarization of the anode and the metal tank with a potential difference therebetween. The cathode and the anode contact the electrolyte to form an electrochemical cell.

In yet other implementations, a kit for assembling a rooftop garden includes an internally coated metal tank for receiving growth media containing an electrolyte. An anode for inserts into the metal tank. The anode electrically contacts the metal tank to polarize the anode and the metal tank with a potential difference therebetween. The metal tank forms a cathode when the metal tank and the anode contact the electrolyte within the growth media. The anode, the cathode, and the electrolyte form an electrochemical cell.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a fragmentary side view in cross section of a rooftop garden positioned on the top of building in accordance with the subject matter of this disclosure.

FIG. 2 is a perspective view of a rooftop garden in accordance with the subject matter of this disclosure.

FIG. 3 is a top plan view of the rooftop garden shown in FIG. 2 in accordance with the subject matter of this disclosure.

FIG. 4 is a block diagram of another embodiment of a rooftop garden in accordance with the subject matter of this disclosure.

FIG. 5 is a block diagram of another embodiment of a rooftop garden in accordance with the subject matter of this disclosure.

FIG. 6 is a block diagram of another embodiment of a rooftop garden in accordance with the subject matter of this disclosure.

FIG. 7 is a block diagram of another embodiment of a rooftop garden in accordance with the subject matter of this disclosure.

FIG. 8 is an exemplary process in accordance with the subject disclosure.

### DETAILED DESCRIPTION

The subject disclosure is directed to a rooftop garden and, more particularly, to a rooftop garden that includes a metal tank that utilizes cathodic protection within growth media. The cathodic protection can be accomplished with a sacrificial anode (i.e., galvanic protection), an impressed current, or through a hybrid of both techniques.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

The subject disclosure is directed to a rooftop garden that can be protected from corrosion by using cathodic protection. Cathodic protection can be a protection methodology that is particularly useful in preventing corrosion attack that can result from the typical rooftop garden environment. The rooftop garden can be protected using galvanic cathodic protection, impressed current cathodic protection, or hybrid galvanic/impressed current cathodic protection.

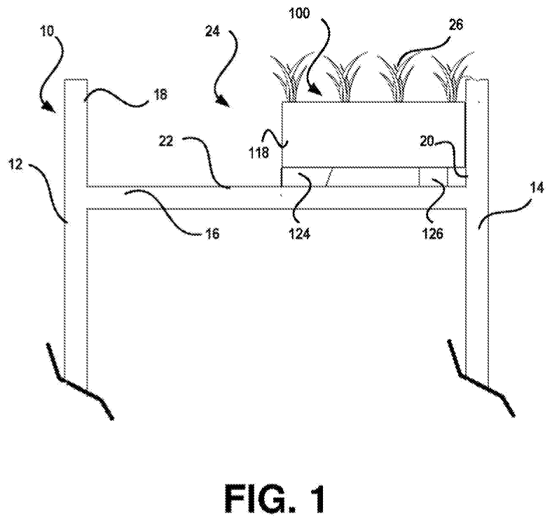

Referring now to FIGS. 1-3, there is shown a building, generally designated by the numeral 10. The building 10 includes a pair of walls 12-14 and a roof 16. Each of the walls 12-14 includes an upper interior surface 18-20 that extends above an upper surface 22 of the roof 16. The wall upper interior surfaces 18-20 and the roof upper surface 22 define a deck 24 for supporting a rooftop garden, generally designated with the numeral 100, for holding a plurality of plants 26 stored therein.

The rooftop garden 100 includes soil and/or growth media (not shown) that facilitates growth of the plants 26. Soil and growth media can include natural or artificial mixtures of organic matter, minerals, gases, liquids, and/or organisms that support life. Soil can function as a medium for plant growth, as a means of water storage, supply and purification, as a modifier of adjacent atmosphere, and as a habitat for organisms.

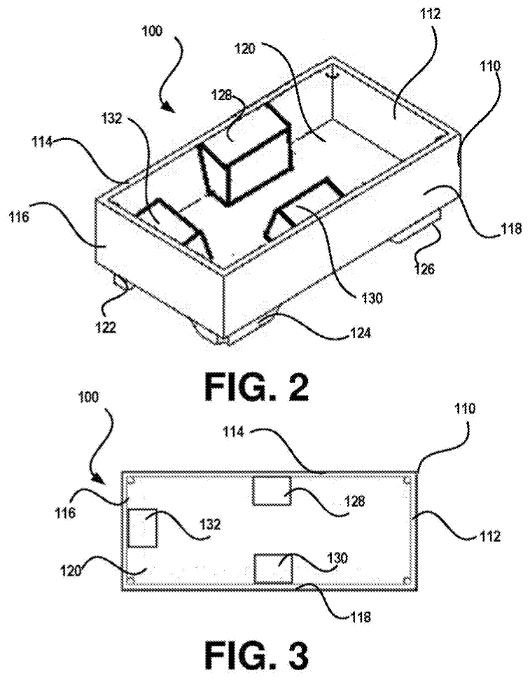

As shown in FIGS. 2-3, the rooftop garden 100 includes a body 110 that defines a tank. The body 110 has a plurality of walls 112-118 and base 120. The body 110, the walls 112-118, and the base 120 have an essentially rectilinear configuration, but the geometric configuration is not critical, provided that the body 110 can hold soil and/or growth media for the plants 26 therein. The rooftop garden 100 can be provided as a fully-assembled apparatus, partially assembled, or as a kit of components for assembly by the ultimate consumer.

The base 120 is supported by a plurality of support members 122-126. The body 110 is constructed from metal for ease of fabrication and to minimize leakage. The use of metal provides for an efficient structure. In some embodiments, the body 110 is constructed from stainless steel.

The rooftop garden 100 includes a plurality of anodes 128-132 to protect the body 110 from corrosion when soil or other growth media is placed therein. The soil and/or growth media can include an aqueous component and electrolyte, so that the body 110 and the anodes 128-132 form an electrochemical cell.

Each of the anodes 128-132 can function as a sacrificial anode in a galvanic cathodic protection system, as an anode in an impressed cathodic protection system, or as a hybrid-type anode in a hybrid system. In a galvanic system, the body 110 can be formed from stainless steel, and the anodes 128-132 can be formed from metals that are below stainless steel on the galvanic series. Such metals can include indium, aluminum, uranium, cadmium, beryllium, zinc, magnesium, and/or alloys that include one or more of those metals.

As shown in FIGS. 2-3, the body 110 is in contact with the anodes 128-132, which is suitable for galvanic systems. In impressed current systems, the anodes 128-132 cannot be in contact with the body 110.

In some embodiments, each of the anodes 128-132 weighs between about 10 pounds to about 20 pounds. In this exemplary embodiment, each of the anodes weighs about 17 pounds. In other embodiments, each of the anodes 128-132 can weigh between about 3-5 pounds. Additional embodiments that include anodes 128-132 that weigh more than about 3-5 pounds are contemplated. The size of the anodes 128-132 depend upon planter size and geometry.

Similarly, the geometry of the anodes 128-132 is not critical. In some embodiments, the anodes 128-132 can be ribbon anodes.

The body 110, including the walls 112-118 and the base 120, can include a coating formed from ceramics, plastics, and/or composites. Suitable plastic coating materials includes thermoplastics, thermoset plastics, network polymers, rubbers, elastomers, and/or plastomers. In this exemplary embodiment, the coating can be formed from an epoxy compound.

Similarly, the anodes 128-132 can include a coating formed from ceramics, plastics, and/or composites. Suitable coating materials can include organic coating materials, such as epoxy and polyurethane coating materials and/or paints. In this exemplary embodiment, the coating can be paint.

The coating can have a thickness of between about 0.01 inches and about 0.02 inches. In this exemplary embodiment, the coating has a thickness of about 0.012 inches. In such embodiments, about 0.01 inches represents a minimum coating thickness.

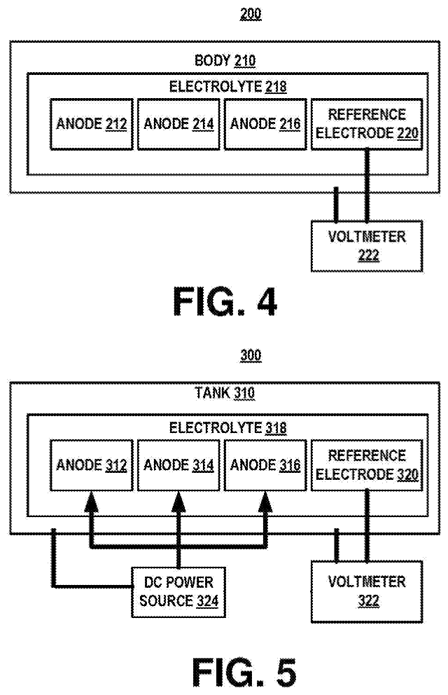

Referring now to FIG. 4 with continuing reference to the foregoing figures, another embodiment of a rooftop garden, generally designated by the numeral 200, is shown. Like the embodiment shown in FIGS. 1-3, the rooftop garden 200 includes a body 210 and a plurality of anodes 212-216. The body 210 and the plurality of anodes 212-216 function in essentially the same manner as the body 110 and the anodes 128-132 shown in FIGS. 1-3.

The rooftop garden 200 also includes an electrolyte 218, so that the body 210, the anodes 212-216, and the electrolyte 218 form an electrochemical cell for protecting the rooftop garden 200.

Unlike the embodiment shown in FIGS. 1-3, the rooftop garden 200 includes a reference electrode 220 that inserts into soil and/or growth media in the body 210 and a voltmeter 222 connected to the reference electrode 220. The voltmeter 222 can be used to measure the potential of the reference electrode 220 to monitor the corrosion of the anodes 212-216 over time. The reference electrode 220 can be a permanent reference electrode or a temporary electrode.

Referring now to FIG. 5 with continuing reference to the foregoing figures, another embodiment of a rooftop garden, generally designated by the numeral 300, is shown. Like the embodiment shown in FIG. 4, the rooftop garden 300 includes a body 310, a plurality of anodes 312-316, electrolyte 318, a reference electrode 320, and a voltmeter 322. The body 310, the anodes 312-216, and the electrolyte 318 form an electrochemical cell for protecting the rooftop garden 300. The reference electrode 320 and the voltmeter 322 can be used to monitor the consumption of the plurality of anodes 312-316 by measuring the voltage of the reference electrode 320 over time.

Unlike the embodiment shown in FIG. 4, the rooftop garden 300 includes a DC power source 324 for supplying a current to the body 310, the anodes 312-316, and the reference electrode 320. The impressed current supplied by the DC power source 324 can provide cathodic protection to the rooftop garden 300 as an impressed current system or as a hybrid galvanic/impressed system. The DC power source 324 can be a battery or a DC power generator.

In impressed current systems, the anodes 312-316 must not be in direct contact with the body 310. Further, it should be understood that the reference electrode 320 and the voltmeter 322 are for monitoring the system.

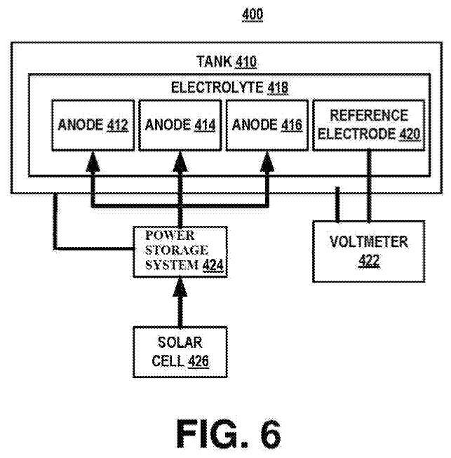

Referring now to FIG. 6 with continuing reference to the foregoing figures, another embodiment of a rooftop garden, generally designated by the numeral 400, is shown. Like the embodiment shown in FIG. 5, the rooftop garden 400 includes a body 410, a plurality of anodes 412-416, electrolyte 418, a reference electrode 420, and a voltmeter 422. The body 410, the anodes 412-416, and the electrolyte 418 form an electrochemical cell for protecting the rooftop garden 400. The reference electrode 420 and the voltmeter 422 can be used to monitor the consumption of the plurality of anodes 412-416 by measuring the voltage of the reference electrode 420 over time.

Unlike the embodiment shown in FIG. 5, the rooftop garden 400 includes a DC power storage system 424 for supplying a current to the body 410, the anodes 412-416, and the reference electrode 420 that functions in essentially the same way as the DC power source 324 shown in FIG. 5. The power storage system 424 receives power from a solar cell 426.

It should be understood that solar power sources can be intermittent sources of power, so that such power sources can be connect to electrical power storage units, such as batteries. Accordingly, the power storage system 424 can be a battery, such as a rechargeable battery. In other embodiments, the solar cell 426 can be replaced by or supplemented with a wind power source, a natural gas generator, or other similar power source.

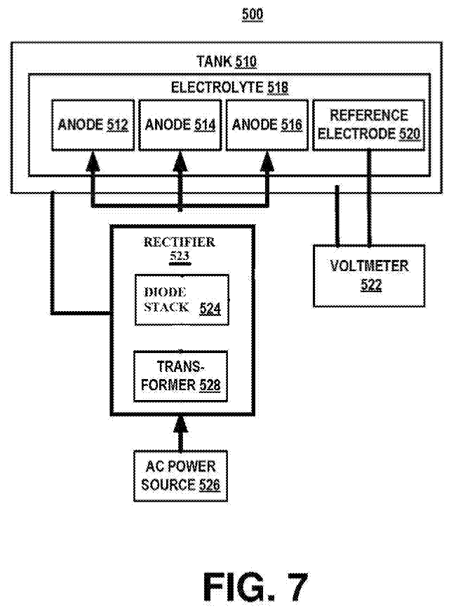

Referring now to FIG. 7 with continuing reference to the foregoing figures, another embodiment of a rooftop garden, generally designated by the numeral 500, is shown. Like the embodiment shown in FIG. 6, the rooftop garden 500 includes a body 510, a plurality of anodes 512-516, electrolyte 518, a reference electrode 520, and a voltmeter 522. The and

The body 510, the anodes 512-516, and the electrolyte 518 form an electrochemical cell for protecting the rooftop garden 500. The reference electrode 520 and the voltmeter 522 can be used to monitor the consumption of the plurality of anodes 512-516 by measuring the voltage of the reference electrode 520 over time. The rooftop garden 500 includes a rectifier 523, a diode stack 524, an AC power source 526, and a transformer 528. The AC power source 526 can provide an impressed current on the body 510, the anodes 512-516, and the reference electrode 520 through the rectifier 523.

Unlike the embodiment shown in FIG. 6, the rectifier 523 receives power from an AC power source 526. The AC power source 526 sends power through a diode stack 524 and the transformer 528.

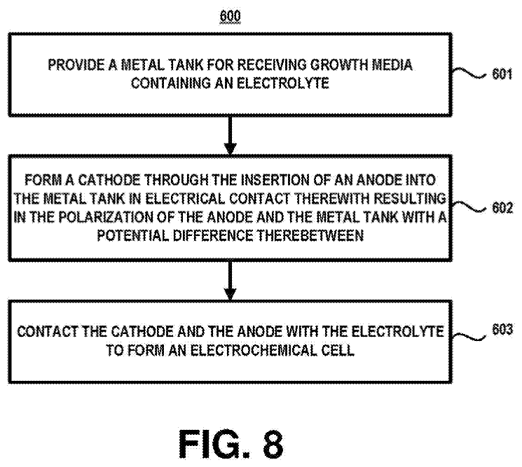

Referring now to FIG. 8 with continuing reference to the foregoing figures, an exemplary method, generally designated with the numeral 600, for assembling a rooftop garden is shown. The method 600 can be performed to produce the rooftop garden 100 shown in FIGS. 1-3, the rooftop garden 200 shown in FIG. 4, the rooftop garden 300 shown in FIG. 5, the rooftop garden 400 shown in FIG. 6 and/or the rooftop garden 400 shown in FIG. 7.

At 501, a metal tank for receiving growth media containing an electrolyte is provided. In this exemplary embodiment, the metal tank can be the body 110 shown in FIGS. 1-3, the body 210 shown in FIG. 4, the body 310 shown in FIG. 5, the body 410 shown in FIG. 6 and/or the body 510 shown in FIG. 7.

At 502, a cathode is formed through the insertion of an anode into the metal tank in electrical contact therewith resulting in the polarization of the anode and the metal tank with a potential difference therebetween. In this exemplary embodiment, the anode can be the anodes 128-132 shown in FIGS. 1-3, the anodes 212-216 shown in FIG. 4, the anodes 312-316 shown in FIG. 5, the anodes 412-416 shown in FIG. 6 and/or the anodes 512-516 shown in FIG. 7.

At 503, the cathode and the anode contact the electrolyte to form an electrochemical cell. In this exemplary embodiment, the electrochemical cell can provide galvanic protection for the tank. In other embodiments, the instrumentality for performing the method can include DC power sources, such as batteries or solar cells, or AC power sources, which provide AC power that is converted to DC power, to provide an impressed current to protect the tank.

### Supported Features and Embodiments

The detailed description provided above in connection with the appended drawings explicitly describes and supports various features of a rooftop garden and methods for assembling the rooftop garden. By way of illustration and not limitation, supported embodiments include a rooftop garden comprising: a metal tank for receiving growth media containing an electrolyte, and an anode positioned within the growth media in electrical contact with the metal tank to polarize the anode and the metal tank with a potential difference therebetween, wherein the metal tank forms a cathode when the metal tank forms the potential difference with the anode, and wherein the anode, the cathode, and the electrolyte form an electrochemical cell.

Supported embodiments include the foregoing rooftop garden, further comprising a plurality of anodes.

Supported embodiments include any of the foregoing rooftop gardens, wherein each of the plurality of anodes is essentially identical.

Supported embodiments include any of the foregoing rooftop gardens, wherein each of the plurality of anodes weighs between about 10 pounds to about 20 pounds.

Supported embodiments include any of the foregoing rooftop gardens, wherein the anode is a sacrificial anode.

Supported embodiments include any of the foregoing rooftop gardens, wherein the metal tank is formed from stainless steel and the anode is formed from a metal that is below stainless steel on the galvanic series.

Supported embodiments include any of the foregoing rooftop gardens, wherein the anode is formed from a metal selected from the group consisting of zinc and magnesium.

Supported embodiments include any of the foregoing rooftop gardens, further comprising: a reference electrode, and a voltmeter for measuring voltage of the reference electrode and the output current of the anode.

Supported embodiments include any of the foregoing rooftop gardens, further comprising: a DC power source connecting to the anode to impress a potential difference between the anode and the cathode.

Supported embodiments include any of the foregoing rooftop gardens, wherein the DC power source is a solar cell.

Supported embodiments include any of the foregoing rooftop gardens, wherein the DC power source includes an AC power source and a transformer.

Supported embodiments include any of the foregoing rooftop gardens, wherein the metal tank includes a plastic coating thereon.

Supported embodiments include any of the foregoing rooftop gardens, wherein the plastic coating includes an organic coating material.

Supported embodiments include any of the foregoing rooftop gardens, wherein the organic coating material includes an epoxy.

Supported embodiments include any of the foregoing rooftop gardens, wherein the organic coating material has a thickness of between about 0.01 inches and about 0.02 inches.

Supported embodiments include a kit, a method, an apparatus, and/or means for implementing any of the foregoing rooftop gardens or a portion thereof.

Supported embodiments include a method for assembling a rooftop garden, the method comprising: providing a metal tank for receiving growth media containing an electrolyte, forming a cathode through the insertion of an anode into the metal tank in electrical contact therewith resulting in the polarization of the anode and the metal tank with a potential difference therebetween, and contacting the cathode and the anode with the electrolyte to form an electrochemical cell.

Supported embodiments include the foregoing method, further comprising: inserting a plurality of anodes into the metal tank.

Supported embodiments include any of the foregoing methods, wherein the anode is a sacrificial anode.

Supported embodiments include any of the foregoing methods, further comprising: forming the metal tank from stainless steel; and forming the anode from a metal that is below stainless steel on the galvanic series.

Supported embodiments include any of the foregoing methods, further comprising: inserting a reference electrode into the metal tank, and connecting a voltmeter to the reference electrode to monitor the voltage of the reference electrode and the output current of the anode.

Supported embodiments include any of the foregoing methods, further comprising: connecting a DC power source to the anode to impress a potential difference between the anode and the cathode.

Supported embodiments include any of the foregoing methods, further comprising: converting solar energy into a DC current using a solar cell; and providing the DC current to the anode to impress a potential difference between the anode and the cathode.

Supported embodiments include any of the foregoing methods, further comprising: receiving an AC current from an AC power source; converting the AC current to a DC current with a transformer; and providing the DC current to the anode to impress a potential difference between the anode and the cathode.

Supported embodiments include an apparatus, a kit, a system, and/or means for implementing any of the foregoing methods or a portion thereof.

Supported embodiments include a kit for assembling a rooftop garden, the kit comprising: a metal tank for receiving growth media containing an electrolyte, and an anode for inserting into the metal tank, wherein the anode electrically contacts the metal tank to polarize the anode and the metal tank with a potential difference therebetween, wherein the metal tank forms a cathode when the metal tank and the anode contact the electrolyte within the growth media, and wherein the anode, the cathode, and the electrolyte form an electrochemical cell.

Supported embodiments include the foregoing kit, further comprising a plurality of anodes.

Supported embodiments include any of the foregoing kits, further comprising: a reference electrode, and a voltmeter for measuring voltage of the reference electrode and the output current of the anode.

Supported embodiments include any of the foregoing kits, further comprising: a DC power source for connecting to the anode to impress a potential difference between the anode and the cathode.

Supported embodiments include any of the foregoing kits, further comprising an AC power source and a transformer.

Supported embodiments include any of the foregoing kits, further comprising a solar cell for connecting to the anode to impress a potential difference between the anode and the cathode.

Supported embodiments include any of the foregoing kits, wherein the metal tank includes a plastic coating thereon.

Supported embodiments include any of the foregoing kits, wherein the plastic coating includes an epoxy.

Supported embodiments include any of the foregoing kits, wherein the plastic coating has a thickness of between about 0.01 inches and about 0.02 inches.

Supported embodiments include an apparatus, a method, a system, and/or means for implementing any of the foregoing kits or a portion thereof.

Supported embodiments can provide various attendant and/or technical advantages in terms of a metal rooftop garden that can be protected from corrosion using galvanic cathodic protection, impressed current cathodic protection, or hybrid galvanic/impressed cathodic protection. The use of a metal rooftop garden provides a more efficient structure that is subject to fewer leaks, as compared to conventional concrete rooftop garden structures.

Supported embodiments include a rooftop garden that can include a carbon steel tank that can be protected from corrosion for twenty to thirty years.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A rooftop garden comprising:
a metal tank for receiving growth media containing an electrolyte, and
an anode positioned within the growth media in electrical contact with the metal tank to polarize the anode and the metal tank with a potential difference therebetween,
wherein the metal tank becomes a cathode when a potential difference is established between the metal tank and the anode, and
wherein the anode, the cathode, and the electrolyte form an electrochemical cell.

2. The rooftop garden of claim 1, further comprising a plurality of anodes.

3. The rooftop garden of claim 2, wherein each of the plurality of anodes is essentially identical.

4. The rooftop garden of claim 2, wherein each of the plurality of anodes weighs between about 10 pounds to about 20 pounds.

5. The rooftop garden of claim 1, wherein the anode is a sacrificial anode.

6. The rooftop garden of claim 5, wherein the metal tank is formed from stainless steel and the anode is formed from a metal that is below stainless steel on the galvanic series.

7. The rooftop garden of claim 6, wherein the anode is formed from a metal selected from the group consisting of zinc and magnesium.

8. The rooftop garden of claim 1, further comprising:
a reference electrode, and
a voltmeter for measuring voltage of the reference electrode and the output current of the anode.

9. The rooftop garden of claim 1, further comprising:
a DC power source connecting to the anode to impress a potential difference between the anode and the cathode.

10. The rooftop garden of claim 9, wherein the DC power source is a solar cell.

11. The rooftop garden of claim 9, wherein the DC power source includes an AC power source and a transformer.

12. The rooftop garden of claim 1, wherein the metal tank includes a plastic coating thereon.

13. The rooftop garden of claim 12, wherein the plastic coating includes an organic coating material.

14. The rooftop garden of claim 13, wherein the organic coating material includes an epoxy.

15. The rooftop garden of claim 13, wherein the organic coating material has a thickness of between about 0.01 inches and about 0.02 inches.

16. A method for assembling a rooftop garden, the method comprising:
providing a metal tank for receiving growth media containing an electrolyte,
forming a cathode through the insertion of an anode into the metal tank in electrical contact therewith resulting in the polarization of the anode and the metal tank with a potential difference therebetween, and
contacting the cathode and the anode with the electrolyte to form an electrochemical cell.

17. The method of claim 16, further comprising:
inserting a plurality of anodes into the metal tank.

18. The method of claim 16, wherein the anode is a sacrificial anode.

19. The method of claim 16, further comprising:
forming the metal tank from stainless steel; and
forming the anode from a metal that is below stainless steel on the galvanic series.

20. The method of claim 16, further comprising:
inserting a reference electrode into the metal tank, and
connecting a voltmeter to the reference electrode to monitor the voltage of the reference electrode and the output current of the anode.
